(19) United States
(12) Patent Application Publication
(10) Pub. No.: US 2022/0029543 A1
(43) Pub. Date: Jan. 27, 2022

(54) FLYBACK CONVERTER HAVING TWO OR MORE INDEPENDENT OUTPUT STAGES

(71) Applicants: thyssenkrupp Presta AG, Eschen (LI); thyssenkrupp AG, Essen (DE)

(72) Inventor: Zoltán BARANYAI, Herceghalom (HU)

(73) Assignees: thyssenkrupp Presta AG, Eschen (LI); thyssenkrupp AG, Essen (DE)

(21) Appl. No.: 17/297,532

(22) PCT Filed: Dec. 2, 2019
(86) PCT No.: PCT/EP2019/083260

§ 371 Date: May 27, 2021

(51) Int. Cl. H02M 3/335; H02M 1/32; B60L 53/20

(52) U.S. Cl. CPC H02M 3/33561; H02M 3/33576; B60L 2210/10; B60L 53/20; H02M 1/32

(57) ABSTRACT

A power supply unit for an electrical control device having a transformer with a primary coil that can be actuated by means of a switchable primary switch and at least one secondary coil. The primary coil and the at least one secondary coil are arranged on a common magnetic core. The secondary coil provides at least two outputs with controllable output voltages, and the secondary coil is assigned a switchable secondary switch for each of the at least two outputs. The power supply unit comprises a signal processing and calculation unit that is set up to actuate the primary switch and the secondary switches by means of pulse generators. The outputs may be switched sequentially to provide at least two controllable output voltages.

The present invention relates to a power supply unit with the features of the preamble of claim 1 and to a method for supplying power to an electronic motor vehicle control device with the features of the preamble of claim 12.

Current electronic motor vehicle control devices contain SBCs (system basis chips), ASICs or a discrete implementation of several supply architectures or a combination thereof: buck switched-mode power converters (SMPs), cascaded buck-boost switched-mode power supplies (SMPSs), flyback converters (flyback SMPSs) and linear regulators. These contain controllers based on analog PI or PID controllers.

The power supply is an important, expensive and thermally relevant part of electronic control devices. Conventional power supplies have multiple outputs with high loads, which means that devices for this purpose are expensive. Control units and regulators are implemented separately. Switched-mode power supplies (SMPSs) are increasingly being used to replace conventional linear AC power supply units, thereby lowering power consumption and reducing heat dissipation as well as the size and weight of the component. However, since switched-mode power supplies require a complex control unit, a maximum of one to two outputs are implemented with switched-mode power supplies. The rest of the outputs are generated with linear regulators, LDOs for short, which produce considerable heat and require large transistors.

It is the object of the present invention to specify a power supply unit that provides a particularly simple and inexpensive power supply for an electronic control device.

This object is achieved by a power supply unit for an electronic control device with the features of claim 1 and by a method for supplying power to an electronic motor vehicle control device with the features of claim 12. Advantageous developments of the invention are mentioned in the dependent claims.

Accordingly, provision is made of a power supply unit for an electronic control device, in particular a motor vehicle control device, having a transformer with a primary coil that can be actuated by means of a switchable primary switch and with at least one secondary coil, wherein the primary coil and the at least one secondary coil are arranged on a common magnetic core, and the at least one secondary coil provides at least two outputs with controllable output voltages, wherein the at least one secondary coil is assigned a switchable secondary switch for each of the at least two outputs, and wherein the power supply unit comprises a signal processing and calculation unit, which is set up to actuate the primary switch and the secondary switches by means of pulse generators, wherein the at least two outputs are connected sequentially in order to provide at least two controllable output voltages.

With this digital control, complex, intelligent and robust regulation can be realized. It becomes practically possible to create a power supply unit with multiple outputs, wherein all outputs are regulated. In this way, no linear regulators are required.

In a preferred embodiment, at least two secondary coils are provided, wherein the primary coil and the at least two secondary coils are arranged on a common magnetic core, wherein a switchable secondary switch is connected upstream of each of the at least two secondary coils, and wherein the power supply unit comprises a signal processing and calculation unit, which is set up to actuate the primary switch and the secondary switches by means of pulse generators, wherein the at least two secondary coils are switched sequentially in order to provide at least two controllable, in particular variable, output voltages.

In the context of the invention, however, a secondary coil can also provide several output voltages. For this purpose, the secondary coil is connected to a corresponding number of controllable secondary switches that are connected downstream of the secondary coil. By sequentially switching the secondary switches, the secondary coil can provide several output voltages.

The transformer is preferably part of a clocked flyback converter. The flyback converter has, in particular, a potential isolation, which is used for the galvanically decoupled transmission of electrical energy from the primary side to the secondary side.

It is advantageous when the power supply unit comprises voltage detection circuits, which are set up to measure the output voltages provided by means of the at least one secondary coil and to pass them on to the signal processing and calculation unit. This makes it possible, in particular, to compare the voltage measured by the voltage detection circuits with predeterminable setpoint values. This comparison can be made by comparators and used to regulate the output voltages. It can also be provided that a voltage detection circuit measures the input voltage.

The power supply unit preferably comprises a clock generator for clocking the switching cycles that provides a clock signal for the signal processing and calculation unit.

The power supply unit can have, in particular, a diagnostic unit and/or other functions (such as power up/down sequencing, error handling, reconfiguration) that can be implemented easily and inexpensively. For a possible reconfiguration, the power supply unit preferably has a configuration memory.

It is advantageous when the power supply unit has a communication interface for communication with a main processor of the control device.

In an advantageous embodiment, the power supply unit has an additional primary circuit for storing or reducing excess energy. In another embodiment, a circulator and an additional pulse generator can be provided instead of the additional primary circuit. The additional pulse generator switches a switching element that is assigned to an output in order to produce a short circuit. By means of the circulator, the current is circulated in a coil so that the excess energy is not completely lost but is retained. This energy can be used as a reserve.

It can be provided that the power supply unit has a short-circuit identification device. The short-circuit identification device detects short-circuited outputs, preferably by means of the comparators. If there is a short circuit present, the predetermined setpoint value cannot be reached. The output signals of the pulse generators are therefore compared with predetermined threshold values. If such a threshold value is exceeded, there is a short circuit present, which is detected by the short-circuit identification device.

The primary and/or secondary switches are preferably bipolar transistors, IGBTs or MOSFETs.

In addition, an electronic motor vehicle control device with a power supply unit described above is provided, wherein the power supply unit has output voltages with loads that are greater than 100 mA. The input voltage of the power supply unit is preferably provided by a battery. Furthermore, provision is made of a method for supplying power to an electronic motor vehicle control device with a power supply unit having a transformer with a primary coil that can be actuated by means of a switchable primary switch and at least one secondary coil, wherein the primary coil and the at least one secondary coil are arranged on a common magnetic core, and the at least one secondary coil provides at least two outputs with controllable output voltages, wherein the at least one secondary coil is assigned a switchable secondary switch for each of the at least two outputs, and wherein the power supply unit comprises a signal processing and calculation unit, and in that the method comprises the following method steps:
actuating the primary switch and the at least one secondary switch by means of pulse generators controlled by the signal processing and calculation unit;
outputting a clocked control signal by means of a primary pulse generator to the primary switch so that the primary switch is switched on for a certain time, as a result of which a current flows through the primary coil and generates a magnetic field in the magnetic core and the primary switch then goes into the off state for a certain time;
sequentially switching on the at least two outputs by means of the secondary switches during the off state of the primary switch, wherein the switch-on process in each case lasts until a setpoint value of the respective output voltage is reached or a predetermined time is exceeded.

The method allows regulated output voltages to be provided at a power supply unit in a simple manner. The regulation of all output voltages takes place here using only a single common signal processing and calculation unit.

It is preferred when the method comprises the following further method steps:
measuring the output voltages provided by means of the at least one secondary coil and passing the signal values on to the;
comparing the measured signal values with predeterminable setpoint values in the signal processing and calculation unit for regulating the switch-on processes of the secondary switches. The comparison is preferably carried out by means of comparators. It can also be provided that the input voltage is also measured and the value is passed on to the signal processing and calculation unit for regulation.

In a preferred embodiment, at least two secondary coils are provided, wherein the primary coil and the at least two secondary coils are arranged on a common magnetic core, and wherein a switchable secondary switch is connected upstream of each of the at least two secondary coils, and wherein the power supply unit comprises a signal processing and calculation unit, and the method comprises the following method steps:
actuating the primary switch and the at least two secondary switches by means of pulse generators controlled by the signal processing and calculation unit;
outputting a clocked control signal by means of a primary pulse generator to the primary switch so that the primary switch is switched on for a certain time, as a result of which a current flows through the primary coil and generates a magnetic field in the magnetic core and the primary switch then goes into the off state for a certain time;
after the magnetic field has been generated, the at least two secondary coils are switched on sequentially while the primary switch is in the off state, wherein the switch-on process of a secondary coil in each case lasts until a setpoint value of the respective output voltage is reached or a predetermined time is exceeded.

The method preferably comprises the following further method step:
providing a clock signal for the signal processing and calculation unit by means of a clock generator for clocking the switching processes.

The transformer is preferably actuated in such a way that the output voltages rise continuously. For this purpose, the corresponding setpoint value of the output voltage is continuously increased during a single switch-on process until a target setpoint value is reached. The output voltage then follows the setpoint value and can thus be slowly increased in a targeted manner.

The power supply unit can have, in particular, a diagnostic unit and/or other functions (such as power up/down sequencing, error handling, reconfiguration) that can be implemented easily and inexpensively. For a possible reconfiguration, the power supply unit preferably has a configuration memory.

It is advantageous when the power supply unit has a communication interface for communication with a main processor of the control device.

In an advantageous embodiment, the power supply unit has an additional primary circuit for storing or reducing excess energy. In another embodiment, a circulator and an additional pulse generator can be provided instead of the additional primary circuit. The additional pulse generator switches a switching element that is assigned to an output in order to produce a short circuit. By means of the circulator, the current is circulated in a coil so that the excess energy is not completely lost but is retained. This energy can be used as a reserve.

It can be provided that the power supply unit has a short-circuit identification device. The short-circuit identification device detects short-circuited outputs, preferably by means of the comparators. If there is a short circuit present, the predetermined setpoint value cannot be reached. The output signals of the pulse generators are therefore compared with predetermined threshold values. If such a threshold value is exceeded, there is a short circuit present, which is detected by the short-circuit identification device.

The primary and/or secondary switches are preferably bipolar transistors, IGBTs or MOSFETs.

The input voltage of the power supply unit is preferably provided by a battery.

In addition, an electronic motor vehicle control device with a power supply unit is provided, which is set up to carry out the method described above.

A preferred embodiment of the invention will be explained in more detail hereunder by means of the drawings. Identical or functionally identical components are provided in this case with the same reference signs throughout the figures. In the drawings:

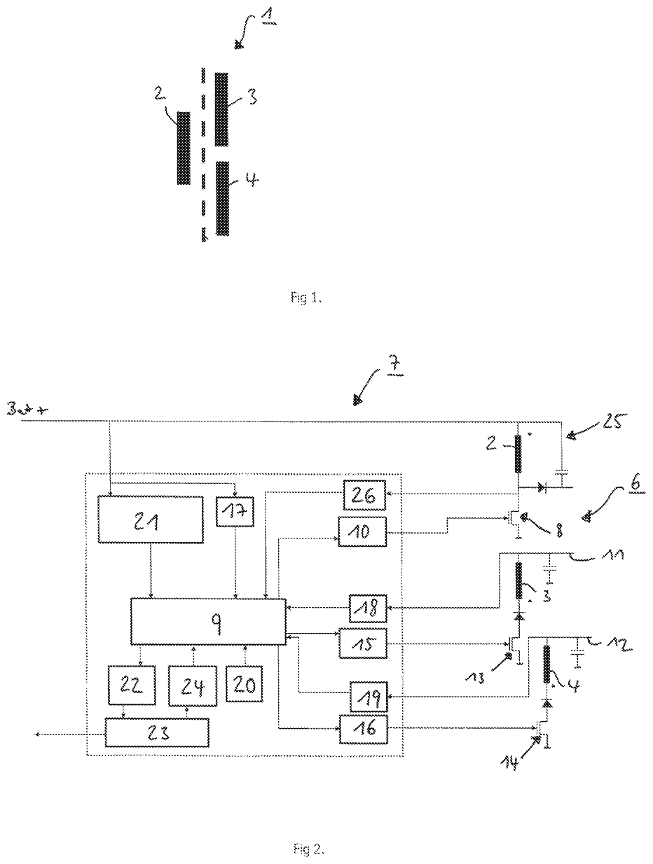

FIG. 1: shows a schematic illustration of a transformer, and

FIG. 2: shows a block diagram of a control system of a power supply of a control device.

The transformer 1 shown in FIG. 1 has a primary coil 2 on a primary side and two secondary coils 3, 4 on a secondary side, which are arranged on a common magnetic core. The AC input voltage applied to the primary coil 2 is thus converted into an AC output voltage, which can be tapped at the secondary coils 3, 4.

As shown in FIG. 2, the transformer 1 is part of a clocked flyback converter 6, which in turn is part of a power supply unit 7 for controlling a power supply of a control device. The flyback converter 6 has a potential isolation, which is used for the galvanically decoupled transmission of electrical energy from the primary side to the secondary side.

The flyback converter 6 is designed as a clocked converter and has a controllable primary switch 8. The controllable primary switch 8 is a power switch, in particular a transistor with an insulated gate electrode, preferably an IGBT or MOSFET. A signal processing and calculation unit 9 switches the controllable primary switch 8 in a clocked manner by means of a primary pulse generator 10. The primary side of the flyback converter 6 is connected to the positive pole of a battery. A positive control pulse switches the transistor of the primary switch 8 on for a certain time. A linearly increasing current flows through the primary coil 2 and generates a magnetic field in the magnetic core, not illustrated. During this time, no current flows in the secondary coils 3, 4. If the control signal switches the primary switch 8 to the off state for a period of time, the two outputs 11, 12 provided on the secondary side are switched on sequentially, wherein an output 11, 12 is switched on preferably until a setpoint value for the output voltage is reached.

To switch the outputs 11, 12 on and off, a secondary switch 13, 14 is assigned to each output 11, 12, said secondary switch also being actuated in a clocked manner by the signal processing and calculation unit 9 via a secondary pulse generator 15, 16.

In this case, a first secondary switch 13 is assigned to a first secondary coil 3 and the second secondary switch 14 is assigned to the second secondary coil 4. The secondary switches 13, 14 are also power switches, in particular transistors with an insulated gate electrode, preferably IGBTs or MOSFETs.

If a positive control pulse switches the first or second secondary switch 13, 14 (external transistor) on for a certain time, a voltage is induced in the first or second secondary coil 3, 4 with the stored magnetic field reducing.

The output voltages provided by means of the secondary coils 3, 4 and the input voltage are measured by means of voltage detection circuits 17, 18, 19 and passed on to the common signal processing and calculation unit 9. The signal processing and calculation unit 9 uses the measured voltages to calculate the control signals for the primary and the secondary pulse generators 10, 15, 16. For this purpose, the actual values measured by the voltage detection circuits 17, 18, 19 are compared with predeterminable setpoint values. For this purpose, a comparator (not illustrated) is preferably provided in each case. If a setpoint value of an output voltage is reached, the corresponding secondary coil 3, 4 is disconnected. For this purpose, the transistor of the secondary switch 13, 14 is switched to the off state. This process is repeated, wherein the secondary coils 3, 4 are switched one after the other. It can also be provided that the secondary coils are switched off after a predetermined period of time, even if the setpoint value of the output voltage has not yet been reached, in order to prevent a short circuit or to ensure overcharge protection.

The number of output voltages is preferably greater than two. In this case, the transformer has at least one secondary coil. In an embodiment that is not illustrated, when a single secondary coil is used, the at least two output voltages are provided by a common secondary coil. For this purpose, the secondary coil is connected in each case to a switchable secondary switch per output. If a positive control pulse switches one of the two secondary switches on for a certain time, a voltage is induced in the secondary coil with the stored magnetic field reducing. The outputs are also switched on here sequentially.

In order to control the timing of the control signals, the signal processing and calculation unit 9 receives a clock signal from a clock generator 20.

The signal processing and calculation unit 9 preferably operates digitally. It is supplied with voltage by an internal supply device 21 connected to the positive pole of the battery.

A diagnostic unit 22 can also be provided for passing diagnostic information on to a main processor, which is not illustrated, of the control device. The diagnostic unit 22 communicates here with the main processor preferably via a communication interface 23.

A configuration memory 24 is preferably also provided, which is arranged between the signal processing and calculation unit 9 and the communication interface 23 and is addressed by the communication interface 23 in order to actuate the signal processing and calculation unit 9.

After a control cycle has run through and both outputs have been supplied with voltage, there may be excess energy present. This excess energy is discharged into an additional primary circuit 25.

The energy stored in the additional primary circuit 25 can be conducted, for example, into the magnetic core of the transformer in order to be able to cover unpredictable changes in the circumstances during a switching cycle. For this purpose, one of the coils 3, 4 is short-circuited. The excess energy can also be used as an output voltage for loads that are not as sensitive to deviations and operate relative to the positive pole of the battery.

The excess energy is measured by means of a detection circuit 26, which passes the value on to the signal processing and calculation unit 9.

A Zener diode (not illustrated) can be provided in the additional primary circuit 25 to dissipate energy. The control signal for the primary pulse generator 10 is controlled as a function of the current flowing in the additional primary circuit 25 and the voltage.

In another embodiment, a circulator and an additional pulse generator can be provided instead of the additional primary circuit. The additional pulse generator switches a switching element that is assigned to an output in order to produce a short circuit. By means of the circulator, the current is circulated in a coil so that the excess energy is not completely lost but is retained. This energy can be used as a reserve. A measuring device measures the circulator current. The additional pulse generator and the primary pulse generator are actuated depending on the measured circulator current.

The flyback converter 6 is preferably designed in such a way that the output voltages rise continuously. For this purpose, the corresponding setpoint value of the output voltage is steadily increased in the comparator. The output voltage then follows the setpoint value and can thus be slowly increased in a targeted manner.

Furthermore, a short-circuit identification device (not illustrated) can be provided. The short-circuit identification device detects short-circuited outputs by means of the comparators. If there is a short circuit present, the predetermined setpoint value cannot be reached. The output signals of the pulse generators are therefore compared with predetermined threshold values. If such a threshold value is exceeded, there is a short circuit present, which is detected by the short-circuit identification device.

The power supply unit is preferably used in electronic motor vehicle control devices that require several supply voltages with high loads (>100 mA). However, the power supply unit can be used if only sensors are connected to the outputs. In this case, only approximately 5 mA is consumed.

1.-17. (canceled)

18. A power supply unit for an electrical control device, the power supply unit comprising:
a transformer with a primary coil that is actuatable by way of a switchable primary switch and with a secondary coil, wherein the primary coil and the secondary coil are disposed on a common magnetic core, wherein the secondary coil provides outputs with controllable output voltages, wherein the secondary coil is assigned a switchable secondary switch for each of the outputs; and
a signal processing and calculation unit configured to actuate the primary switch and the secondary switches by way of pulse generators, wherein the outputs are sequentially connected to provide at least two of the controllable output voltages.

19. The power supply unit of claim 18 wherein the transformer is part of a flyback converter.

20. The power supply unit of claim 18 comprising voltage detection circuits configured to measure the output voltages provided by the secondary coil and to pass the output voltages onto the signal processing and calculation unit.

21. The power supply unit of claim 20 wherein the signal processing and calculation unit comprises comparators configured to compare the output voltages measured by the voltage detection circuits with predetermined setpoint values.

22. The power supply unit of claim 18 comprising a clock generator that provides a clock signal for the signal processing and calculation unit.

23. The power supply unit of claim 18 comprising a diagnostic unit.

24. The power supply unit of claim 18 comprising a communication interface.

25. The power supply unit of claim 18 comprising a configuration memory.

26. The power supply unit of claim 18 comprising a primary circuit for storing or reducing excess energy.

27. The power supply unit of claim 18 comprising a short-circuit identification device.

28. The power supply unit of claim 18 wherein the primary switch and/or the secondary switches are bipolar transistors.

29. The power supply unit of claim 18 wherein the primary switch and/or the secondary switches are IGBTs.

30. The power supply unit of claim 18 wherein the primary switch and/or the secondary switches are MOSFETs.

31. A method for supplying power to an electric motor vehicle control device with a power supply unit comprising a transformer with a primary coil that is actuatable by way of a switchable primary switch and with a secondary coil, wherein the primary coil and the secondary coil are disposed on a common magnetic core, wherein the secondary coil provides outputs with controllable output voltages, wherein the secondary coil is assigned a switchable secondary switch for each of the outputs, the power supply unit comprising a signal processing and calculation unit, the method comprising:
actuating the primary switch and the secondary switches by way of pulse generators controlled by the signal processing and calculation unit;
outputting a clocked control signal by way of a primary pulse generator to the primary switch so that the primary switch is switched on for a first time, as a result of which a current flows through the primary coil and generates a magnetic field in a magnetic core and the primary switch then goes into an off state for a second time; and
sequentially switching on the outputs by way of the secondary switches during the off state of the primary switch, wherein a switch-on process in each case lasts until a setpoint value of the respective output voltage is reached or a predetermined time is exceeded.

32. The method of claim 31 comprising:
measuring the output voltages provided by way of the secondary coil and passing signal values onto the signal processing and calculation unit; and
comparing the signal values with predeterminable setpoint values in the signal processing and calculation unit for regulating the switch-on processes of the secondary switches.

33. The method of claim 31 comprising providing a clock signal for the signal processing and calculation unit by way of a clock generator for clocking the switching processes.

34. The method of claim 31 comprising continuously raising one of the predeterminable setpoint values to a target setpoint value during the respective switch-on process.

35. An electronic motor vehicle control device with the power supply unit of claim 18, wherein the power supply unit includes the output voltages, provided by the secondary coil, with loads that are greater than 100 mA.
